(19) United States
(12) Patent Application Publication
(10) Pub. No.: US 2026/0151925 A1
(43) Pub. Date: Jun. 4, 2026

(54) FOLDING KNIFE

(71) Applicant: HANGZHOU GREAT STAR INDUSTRIAL CO., LTD., Hangzhou City, Zhejiang Province (CN)

(72) Inventor: Yongwei ZHU, Hangzhou City, Zhejiang Province (CN)

(21) Appl. No.: 19/485,191

(22) PCT Filed: Feb. 16, 2023
(86) PCT No.: PCT/CN2023/076524

§ 371 Date: Dec. 24, 2025

(30) Foreign Application Priority Data
Nov. 21, 2022 (CN) 202211454624.1

(51) Int. Cl. B26B 1/04; B26B 5/00

(52) U.S. Cl. CPC B26B 1/048; B26B 5/00

(57) ABSTRACT

The present invention discloses a folding knife, which belongs to the field of manual cutting tools. Conventional folding knives suffer from the drawbacks of cumbersome operation of the locking mechanism for preventing accidental folding, and potential safety hazards as fingers are located in the folding path of the blade during folding. In the present invention, a finger control part protrudes from a side surface of a front end of a handle part for a finger to apply an unlocking force rearward. The handle part is provided with a forward force application contour feature. A distance between the finger control part and the forward force application contour feature is adapted to allow that fingers of a single hand are able to manipulate the finger control part as the same hand grips and controls the forward force application contour feature, and the hand applies a forward control force to the forward force application contour feature as the fingers apply the unlocking force rearward to the finger control part. Therefore, by gripping the forward force application contour feature with one hand and using a finger of the same hand to apply the unlocking force rearward to the finger control part, the hand is caused to apply the forward control force to the forward force application contour feature. The opposing directions of the unlocking force and the control force cause the handle part to be squeezed and controlled in the hand, thereby allowing the fingers to avoid the folding path and then perform the operation of folding or unfolding the folding part.

### CROSS-REFERENCE TO RELATED APPLICATIONS

The present application claims priority to Chinese Patent Application No. CN202211454624.1, filed with the China National Intellectual Property Administration on Nov. 21, 2022, entitled “FOLDING KNIFE”, the entire contents of which are incorporated herein by reference.

### FIELD OF THE INVENTION

The present invention belongs to the field of manual cutting tools, and in particular, to a folding knife.

### DESCRIPTION OF THE PRIOR ART

As a manual cutting tool, the folding knife has a folding part that is pivotally coupled to the handle part via a pivot, enabling it to fold into the handle part and to unfold from the handle part. This allows the knife to assume a compact form for easy storage and carrying when folded, and to be ready for cutting when unfolded. For safety reasons, particularly when in the unfolded configuration during use, it is necessary to prevent the folding part from folding accidentally.

Chinese Invention Patent Application Publication No. CN101374638A discloses a folding tool with a lockback mechanism. The lockback mechanism is supported on a spring arm extending parallel to a knife body. The spring arm may apply a bias force to the lockback mechanism. When intending to fold a blade, the conventional operation involves one hand gripping a handle and pressing a lockback lever, causing a front end of the lockback lever to lift up, while the other hand folds the blade. Such a structure necessitates two-handed operation, making it cumbersome to operate. Moreover, the hand gripping the handle is located in a folding path of the blade, and is therefore exposed to a potential safety hazard.

Chinese Invention Patent Application Publication No. CN1107405A discloses a double cross lock knife. It is a folding knife comprising first and second blades pivotally mounted on a common pivot pin, each being movable between its open and closed positions. A side lock plate is arranged between the first and second blades. The side lock plate comprises a first finger biased toward the first blade so that the first finger engages the first blade in its open position, and a second finger biased toward the second blade so that the second finger engages the second blade in its open position. These fingers can be depressed individually, thereby allowing the locked blade to be released and closed. The manner of use for this folding knife is indicated in FIG. 8 thereof. To fold the knife, the fingers need to be pushed sideways by the thumb, while the blade is folded by the index finger. Although this folding knife structure allows for one-handed operation, it requires the thumb and index finger to work in a sequential and coordinated manner, making the operation cumbersome. Moreover, during the folding operation, the thumb is positioned within the folding path of the blade, which creates a potential safety hazard of the blade accidentally injuring the thumb. To avoid this hazard, it is preferable to move the thumb away from the folding path of the blade during folding; however, removing the thumb readily causes the handle to slip accidentally from the hand.

### SUMMARY OF THE INVENTION

The present invention aims to address the technical problems and overcome the drawbacks of conventional folding knives, namely the cumbersome operation of the locking mechanism for preventing accidental folding, the potential safety hazards caused by fingers being located in the folding path of the blade during folding, and the tendency of the handle part to slip accidentally from the hand, and provides a folding knife that enables reliable single-handed gripping of the handle part, facilitates folding and unfolding, and avoids the potential safety hazards associated with fingers being located in the folding path of the path.

In order to achieve the above purposes, the folding knife according to the present invention comprises a handle part and a folding part pivotally coupled to the handle part via a pivot so as to be folded toward the handle part and unfolded from the handle part, a rear end of the folding part and a front end of the handle part being provided with a locking mechanism for locking the folding part relative to the handle part, characterized in that the locking mechanism comprises a finger control part for unlocking the locking mechanism, the finger control part protrudes from a side surface of the front end of the handle part for a finger to apply an unlocking force (F1) rearward, the handle part is provided with a forward force application contour feature, and a distance between the finger control part and the forward force application contour feature is adapted to allow that fingers of a single hand are able to manipulate the finger control part as the same hand grips and controls the forward force application contour feature, and the hand applies a forward control force to the forward force application contour feature as the fingers apply the unlocking force rearward to the finger control part.

In this folding knife, during the folding or unfolding of the folding part, by applying the unlocking force rearward to the finger control part with a finger while simultaneously applying the forward control force to the forward force application contour feature with the same hand, the opposing directions of the unlocking force and the control force cause the handle part to be squeezed and controlled in the hand, thereby allowing the fingers to avoid the folding path and then perform the operation of folding or unfolding the folding part. In addition, the folding part may be made to pivot about the pivot by a flicking motion, thereby being unfolded or folded.

In practical use, situations often arise where one hand is occupied with a task while the other hand needs to retrieve or store the folding knife. The folding knife according to the present invention can meet such demands, thus facilitating single-handed retrieval and storage for the user.

In an embodiment, the handle part comprises a handle body, and the forward force application contour feature is a shape feature formed on the handle body. Specifically, the shape feature is any one of the following features:
(1) a squeezing part formed at a rear end of the handle body and adapted to be pressed against a palm, where such structure can enable the squeezing part of the handle part to be pressed against the palm, thus relying on the palm to apply the forward control force to the squeezing part, making it easy to grip the handle;
(2) a protrusion and/or a pit located on a side surface of the handle body and adapted for a finger to apply the forward control force, where such protrusion and/or pit is easy to control with fingers, so that when the unlocking force is applied rearward to the finger control part with fingers, a forward control force is generated to squeeze and control the handle in the hand, and such structure conforms to the habit of gripping the handle with a hand, making it easy to grip.

In an embodiment, the handle part comprises a handle body and a structural member provided on the handle body, and the forward force application contour feature is a shape feature formed on the structural member or is provided by the structural member. Specifically, the shape feature is any one of the following features:
(1) a squeezing part located at a rear end of the handle body and adapted to be pressed against a palm, where such structure can enable the squeezing part to be pressed against the palm, thus relying on the palm to apply the forward control force to the squeezing part, making it easy to grip the handle;
(2) a protrusion, loop, recess, or bent edge located on a side surface of the handle part and adapted for a finger to apply the forward control force, where such protrusion, loop, recess, or bent edge is adapted for finger control, so that when the unlocking force is applied rearward to the finger control part with fingers, a forward control force is generated to squeeze and control the handle in the hand.

In an embodiment, the handle part comprises a handle body, and the forward force application contour feature is provided by an accessory provided on the handle body for removal in use.

In an embodiment, the handle part comprises a handle body, and the forward force application contour feature is a squeezing member assembled at a tail of the handle body and configured to increase a contact force with a palm. In this way, the contact force between the handle part and the palm can be increased, avoiding the forward force application contour feature from slipping out of the hand when applying the forward control force to the forward force application contour feature with the hand.

In an embodiment, the handle part comprises a handle body, and the locking mechanism comprises a stop part provided at a rear end of the folding part and a stop rod provided at a front end of the handle body, an end portion of the stop rod serves as the finger control part, the stop rod is configured to operatively move forward or rearward between a first position and a second position, the stop rod, when located at the first position, presses against the stop part to prevent the folding part from pivoting about the pivot, the stop rod, when located at the second position, avoids the stop part to allow the folding part to be pivotable about the pivot, and the stop rod is biased toward the first position via an elastic force. In this structure, the stop rod moves forward or rearward between the first position and the second position, thereby allowing the folding part to be locked or unlocked relative to the handle body. Since the stop rod is biased toward the first position via the elastic force, it only needs to move in one direction from the first position to the second position, and its return from the second position back to the first position is achieved via the elastic force, thus enabling convenient and quick operation.

In an embodiment, the stop part comprises a first stop part and a second stop part, and the stop rod, when located at the first position, presses against the first stop part to prevent the unfolded folding part from being folded toward the handle body or presses against the second stop part to prevent the folded folding part from being unfolded from the handle body. Accordingly, when the stop rod is located at the first position, it can lock the folding part in an unfolded state to prevent accidental folding, and can also lock the folding part in a folded state to prevent accidental unfolding.

In an embodiment, to enhance the smoothness of engagement, the first stop part is one of a straight edge and a recess, and the second stop part is one of a recess and a straight edge.

In an embodiment, a curved transition surface is provided between the first stop part and the second stop part, and the stop rod contacts the curved transition surface via an elastic force to apply damping to the folding part when the folding part is folded toward the handle body and unfolded from the handle body. This damping can locate the folding part at any position between the folded and unfolded states, and can also appropriately constrain the folding part during the folding and unfolding processes, thereby preventing it from becoming uncontrolled due to a lack of constraint. The transition curved surface ensures smooth pivoting of the folding part and prevents jamming.

In an embodiment, the handle body is provided with a transverse through hole, the transverse through hole is a flat elongated hole or an arc-shaped hole extending in a forward and rearward direction, a front end of the flat elongated hole or the arc-shaped hole defines the first position, a rear end of the flat elongated hole or the arc-shaped hole defines the second position, and the stop rod is transversely assembled to the handle body and passes through the transverse through hole, thereby being guided to move forward or rearward. In this way, the stop rod can move smoothly when transitioning between the first position and the second position, while the stop rod is constrained.

In an embodiment, two ends of the stop rod extend beyond a side surfaces of the handle body, thereby allowing the thumb and index finger to operate oppositely from two sides of the handle body, enhancing the stability of gripping the handle body, and helping to prevent impeded movement caused by tilting of the stop rod when the force is applied to only one end of the stop rod.

In an embodiment, a first elastic element for providing the elastic force is assembled on the handle body. Moreover, the structural form of the first elastic element may vary depending on the specific structure.

In an embodiment, the first elastic element is a curved linear spring, an end of the linear spring is supported onto the handle body, and another end of the linear spring acts on the stop rod to apply a forward elastic force to the stop rod. This curved linear spring exhibits relatively soft elastic characteristics, such that it consistently provides an appropriate elastic force when the stop rod is transitioned between the first position and the second position. Moreover, the linear spring occupies little transverse space in the handle body, thereby effectively preventing an increase in the transverse dimension of the handle body due to the arrangement of the first elastic element.

In an embodiment, to facilitate the assembling, an end of the linear spring is provided with a hook, the hook is hung on the stop rod, thereby both facilitating the application of the elastic force to the stop rod and allowing the stop rod to constrain the spring to prevent the spring from becoming displaced.

In an embodiment, the handle body is provided with an accommodating recess, and the linear spring is located in the accommodating recess. Therefore, it can effectively prevent an increase in the transverse dimension of the handle body due to the arrangement of the first elastic element.

In an embodiment, the first elastic element is a torsion spring, an end of the torsion spring is supported onto the handle body, and another end of the torsion spring acts on the stop rod to apply a forward elastic force to the stop rod.

In an embodiment, two first elastic elements are symmetrically provided on the handle body. In this way, the stop rod is uniformly stressed.

In an embodiment, to facilitate the replacement of the blade, the folding part comprises a blade holder and a blade replaceably mounted on the blade holder, the blade holder is pivotally coupled to the handle part via the pivot, the blade holder comprises a holder body and a pressure plate, the holder body is provided with a mounting recess for mounting the blade, the pressure plate is pivotally coupled to the holder body via a pivot pin so as to pivot to expose the mounting recess or cover the mounting recess, the pressure plate comprises a locking recess, the holder body is provided with an operable movable locking pin, and the movable locking pin is inserted into the locking recess via an elastic force when the pressure plate covers the mounting recess.

In an embodiment, to facilitate the operation of the movable locking pin, the holder body is provided with a sliding recess for mounting the movable locking pin, the movable locking pin is disposed in the sliding recess for forward or rearward movement, the movable locking pin comprises a push-operating part protruding from a side surface of the blade holder, and a third elastic element for applying the elastic force to the movable locking pin is provided in the sliding recess.

In an embodiment, to facilitate the manufacturing, the holder body is formed by stacking and fastening plates, and the mounting recess and the sliding recess are formed by stamping a part of the plates.

In an embodiment, the distance between the finger control part and the forward force application contour feature is 8-12.5 cm. In this way, it is suitable for the hands of most people to grip. In the present invention, the finger control part for unlocking the locking mechanism protrudes from the side surface of the front end of the handle part for a finger to apply the unlocking force rearward, the handle part is provided with the forward force application contour feature, the distance between the finger control part and the forward force application contour feature is adapted to allow that fingers of a single hand are able to manipulate the finger control part as the same hand grips and controls the forward force application contour feature, and the hand applies the forward control force to the forward force application contour feature as the fingers apply the unlocking force rearward to the finger control part. Therefore, when folding or unfolding the folding part, by gripping the forward force application contour feature of the handle part with one hand and simultaneously using a finger of the same hand to apply the unlocking force rearward to the finger control part, the hand is caused to apply the forward control force to the forward force application contour feature. The opposing directions of the unlocking force and the control force cause the handle part to be squeezed and controlled in the hand, thereby allowing the fingers to avoid the folding path and then perform the operation of folding or unfolding the folding part. In addition, the folding part may be made to pivot about the pivot by a flicking motion, thereby being unfolded or folded.

The folding knife alters the conventional manner of gripping the handle part when folding and unfolding the blade, and allows the fingers to avoid the folding path while achieving the reliable gripping of the handle part, thereby eliminating the risk of accidental injury to the fingers by the blade during folding. In addition, during folding or unfolding of the folding part, the hand gripping the handle part can perform the operation without altering the gripping posture, thereby enabling convenient and quick operation. In particular, it can be folded or unfolded via a flicking motion, thereby further enhancing the operational convenience.

Further, the locking mechanism in the present invention comprises a stop part provided at a rear end of the folding part and a stop rod provided at a front end of the handle body, an end portion of the stop rod serves as the finger control part, the stop rod is configured to operatively move forward or rearward between a first position and a second position, the stop rod, when located at the first position, presses against the stop part to prevent the folding part from pivoting about the pivot, the stop rod, when located at the second position, avoids the stop part to allow the folding part to be pivotable about the pivot, and the stop rod is biased toward the first position via an elastic force, so that the folding part is locked in the unfolded state or the folded state. In this structure, by operating the stop rod to transition between the first position and the second position, the folding part can be folded toward the handle part and unfolded from the handle part, thereby enabling convenient and quick operation. In particular, during both folding and unfolding, it is convenient and quick to move the stop rod from the first position to the second position with a finger of the hand gripping the handle part.

### BRIEF DESCRIPTION OF THE DRAWINGS

The drawings, which form a part of the present application, are provided to facilitate a further understanding of the present invention. The schematic embodiments of the present invention and the descriptions thereof are intended to explain the present invention, instead of constituting improper limitations on the present invention. Among the drawings:

FIG. 1 is an axonometric view of a folding knife according to Embodiment 1 of the present invention;

FIG. 2 is an axonometric view of the folding knife shown in FIG. 1 from another perspective;

FIG. 3 is an exploded schematic view of a partial structure of a handle part of the folding knife shown in FIG. 1 and FIG. 2;

FIG. 4 is an axonometric view of the structure shown in FIG. 3 from another perspective;

FIG. 5 is an exploded schematic view of another partial structure of the handle part of the folding knife shown in FIG. 3 and FIG. 4;

FIG. 6 is an axonometric view of the structure shown in FIG. 5 from another perspective;

FIG. 7 is an axonometric view of elastic elements symmetrically provided on a stop rod of a folding knife according to Embodiment 1;

FIG. 8 is a schematic view of a stop rod, located at a first position to prevent a folding part from being folded, of a folding knife according to Embodiment 1;

FIG. 9 is a schematic view of a stop rod, located at a second position to avoid a stop part to enable a folding part to be pivotable about a pivot for folding, of a folding knife according to Embodiment 1;

FIG. 10 is a schematic view of a stop rod, located at a first position to prevent a folding part from being unfolded, of a folding knife according to Embodiment 1;

FIG. 11 is a schematic view of a first elastic element adopting another structural form of a folding knife according to Embodiment 2 of the present invention;

FIG. 12 is a schematic view of a first elastic element adopting a torsion spring of a folding knife according to Embodiment 3 of the present invention;

FIG. 13 is a schematic view of an internal structure of a holder body of a folding part of a folding knife according to the present invention;

FIG. 14 is a schematic view of a blade and a movable locking pin removed from the holder body shown in FIG. 13;

FIG. 15 is an exploded schematic view of a structure of a folding part of a folding knife according to the present invention;

FIG. 16 is an axonometric view of the folding part shown in FIG. 15 from another perspective;

FIG. 17 is a side orthographic projection schematic view of the folding knife according to Embodiment 4;

FIG. 18 to FIG. 27 are schematic views of several structures in which a shape feature formed on a handle body serves as a forward force application contour feature in other embodiments;

FIG. 28 to FIG. 36 are schematic views of several structures in which a shape feature formed on a structural member or the structural member serves as a forward force application contour feature in other embodiments;

FIG. 37 to FIG. 38 are schematic views of structures in which an accessory provided on a handle body for removal in use serves as a forward force application contour feature in other embodiments;

FIG. 39 to FIG. 41 are schematic views of structures in which a squeezing member assembled at a tail of a handle body and configured to increase a contact force with a palm serves as a forward force application contour feature in other embodiments; and

FIG. 42 is a schematic view of a folding knife when held and manipulated with a single hand according to the present invention.

### DESCRIPTION OF REFERENCE SIGNS

100 handle part; 101 through hole; 102 accommodating recess; 103 positioning hole; 104 forward force application contour feature; 105 hanging ring; 106 screwdriver bit; 107 bump; 108 belt clip;
110 stop rod; 111 finger control part;
120 first elastic element; 121 hook;
130 rib skeleton;
140 first rib plate;
150 second rib plate;
160 first panel;
170 second panel;
200 pivot;
300 folding part; 301 first stop part; 302 second stop part; 303 curved transition surface;
310 blade holder; 311 holder body; 312 pressure plate; 312a actuating tab; 313 mounting recess; 314 pin shaft; 315 locking recess; 316 movable locking pin; 317 sliding recess; 318 push-operating part 319 third elastic element; 311a first side plate; 311b recess plate; 311c second side plate; 311d first clamping plate; 311e second clamping plate; 311f actuating post;
320 blade;
400 hand; 401 finger.

### DETAILED DESCRIPTION OF THE PREFERRED EMBODIMENTS

In order to make the objectives, technical solutions, and advantages of the present invention clearer, the technical solutions in the embodiments of the present invention will be clearly and completely described below in conjunction with the accompanying drawings in the embodiments of the present invention. Clearly, the described embodiments are only some, rather than all, embodiments of the present invention. Based on the embodiments of the present invention, all other embodiments obtained by those skilled in the art without contributing any inventive labor still fall within the scope of protection of the present invention.

The present invention will be introduced below in detail in conjunction with the specific embodiments and the drawings.

### Embodiment 1

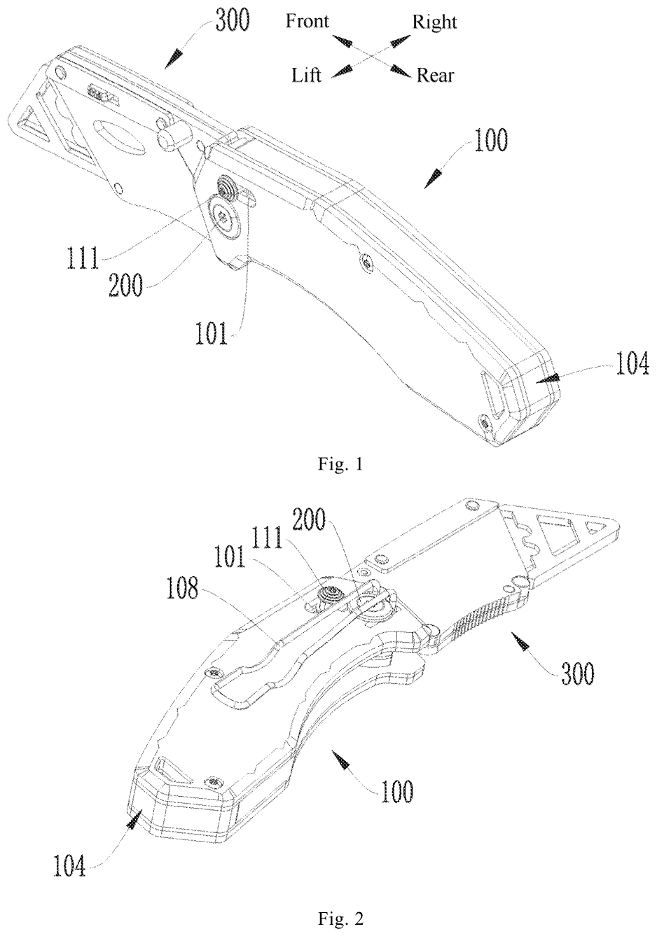

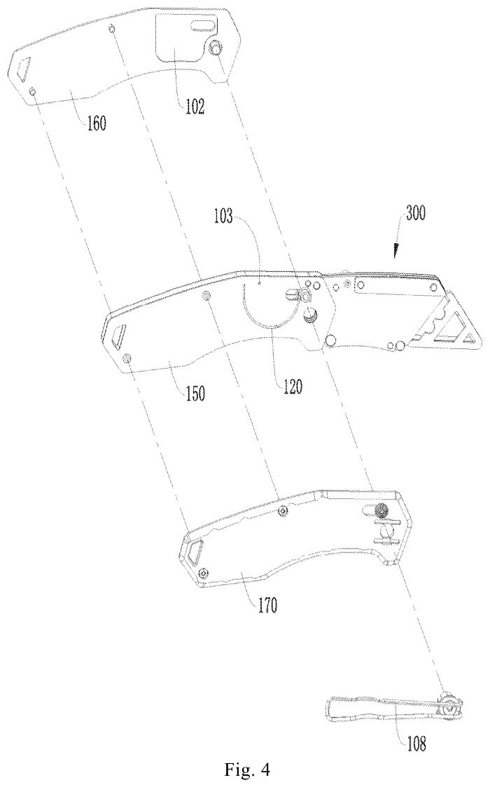

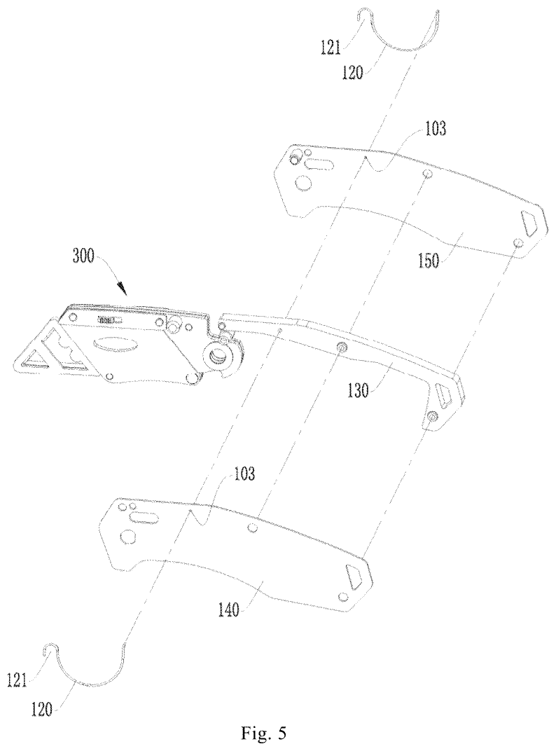

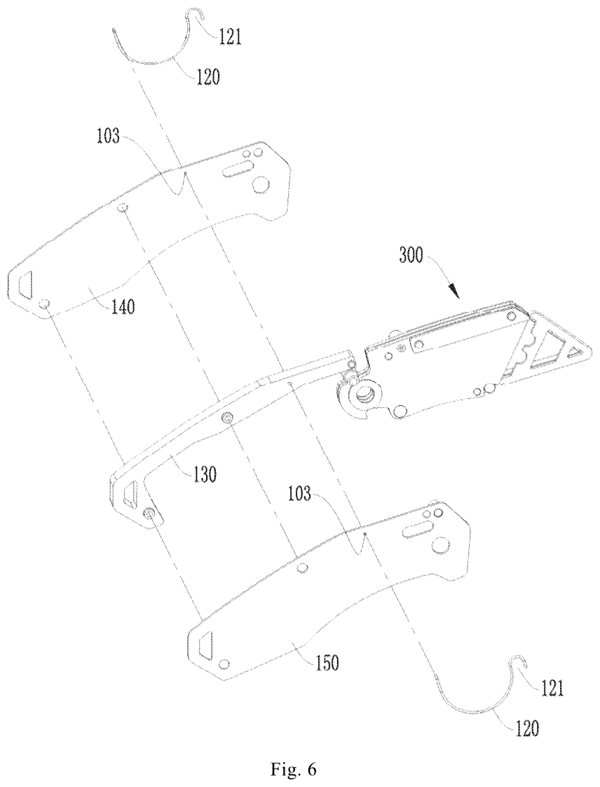

As shown in FIG. 1 to FIG. 6, a folding knife comprises a handle part 100 and a folding part 300 pivotally coupled to the handle part via a pivot 200 so as to be folded toward the handle part and unfolded from the handle part. The handle part comprises a handle body and a belt clip 108 assembled on the handle body. The belt clip is used for securing the folding knife to a belt or the like to facilitate carrying. In this embodiment, the belt clip may be omitted. The portion of the handle part 100 excluding the belt clip is the handle body. The handle body is not assigned a separate reference sign in this embodiment. The folding part 300 shown in FIG. 1 to FIG. 6 is in an unfolded state. It can be readily appreciated that the folding part shown in FIG. 1 to FIG. 6 can be folded toward the handle part by pivoting about the pivot. This situation corresponds to transitioning from an unfolded state shown in FIG. 8 to a folded state shown in FIG. 10.

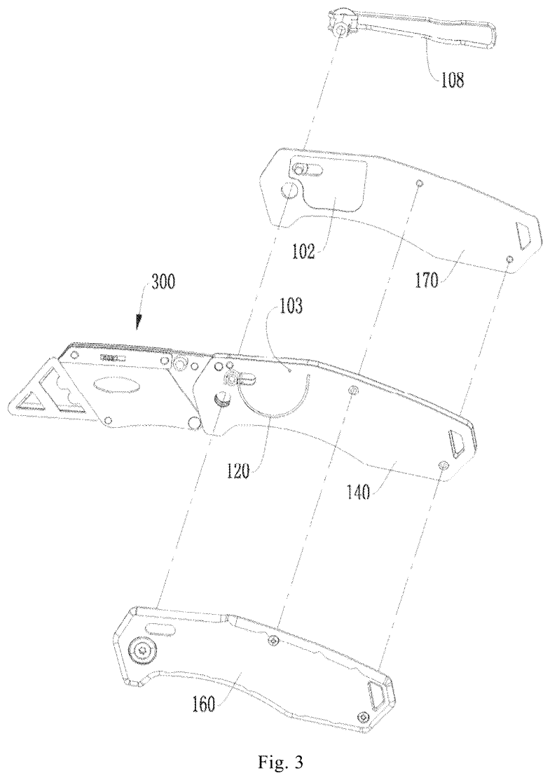

In this embodiment, as shown in detail in FIG. 3 to FIG. 6, the handle body is formed by stacking plates and assembling together via fasteners.

In the figures, the handle body comprises a frame portion and two panels. The frame portion is preferably made from stamped and fastened steel plates, thereby providing substantial strength and rigidity when fastened together. The panels, while optionally made of steel plates, may also be formed from other materials suitable for enhancing grip, such as walnut wood or engineering plastic. Thus, textured patterns may be formed on outer surfaces of the panels. As shown in the figures, the frame portion comprises a rib frame 130 at a middle portion, and a first rib plate 140 and a second rib plate 150 symmetrically fastened on two sides of the rib frame 130. A first panel 160 is affixed to an outer side of the first rib plate 140. A second panel 170 is affixed to an outer side of the second rib plate 150.

Corresponding flat elongated holes are provided at front ends of the rib plates and panels. When the rib plates and panel are assembled together, a transverse through hole 101 is formed on the handle body. A cross-section of the transverse through hole is a flat elongated hole extending in a forward and rearward direction. A stop rod 110 is assembled in the through hole. Two ends of the stop rod respectively extend out of the through hole to side surfaces of the panels. To facilitate the assembling, the stop rod is composed of a shaft section in the middle and end caps coupled to two ends of the shaft section. A diameter of the end cap is larger than the gap of the through hole to prevent the stop rod from slipping out of the through hole. Therefore, a front end of the flat elongated hole defines a first position for the stop rod to move forward or rearward, and a rear end of the flat elongated hole defines a second position for the stop rod to move forward or rearward. In other embodiments, the flat elongated hole may be arranged obliquely on the handle body, with one end higher and the other lower. Alternatively, the flat elongated hole may be replaced by an arc-shaped hole.

Corresponding circular holes are provided at the front ends of the first rib plate, second rib plate, first panel, and second panel. When assembled together, each circular hole forms a pivot hole for assembling the pivot on the handle body.

Positioning holes 103 are provided on the first rib plate and second rib plate. Accommodating recesses 102 are provided on inner sides of the first panel and second panel. A first elastic element 120 is disposed in each accommodating recess. The first elastic element is a curved linear spring, shown in the figures as being bent into a semi-circular arc. A front end of the linear spring is provided with a hook 121. The hook 121 is hung on the stop rod 110. A rear end of the linear spring is inserted into a corresponding positioning hole and is thereby supported onto the handle body. The linear spring applies a forward elastic force to the stop rod, biasing the stop rod toward the first position. Therefore, to operate the stop rod, it is specifically to move the stop rod rearward with a finger, causing the stop rod to move from the first position to the second position. Once the stop rod is released, the stop rod returns forward to the first position under the elastic force of the linear spring, moving from the second position to the first position.

Moreover, as shown in FIG. 3 to FIG. 6 and FIG. 7, two of these first elastic elements are symmetrically arranged on left and right sides of the handle body.

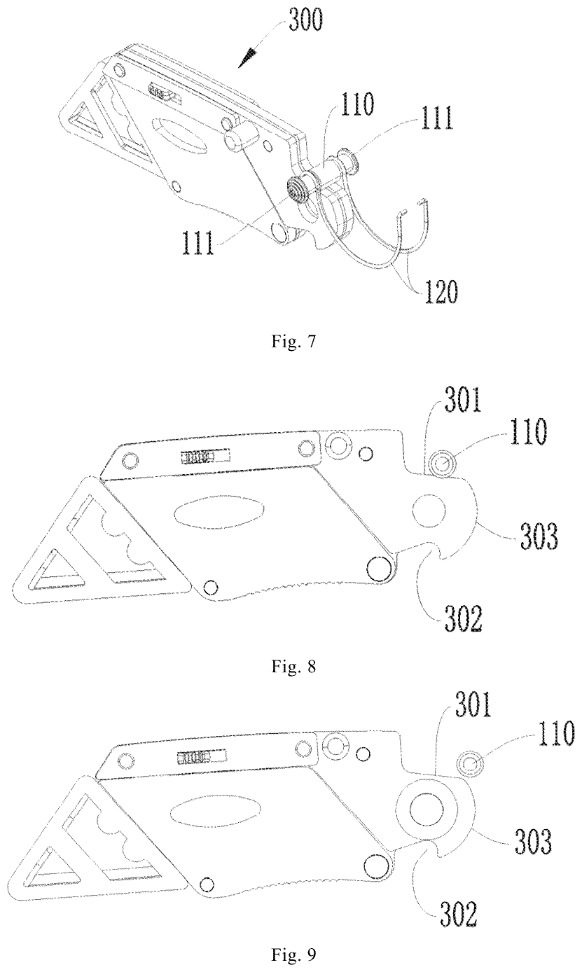

As shown in detail in FIG. 7 to FIG. 10, a rear end of the folding part 300 is provided with a stop part. The stop part comprises a first stop part 301 in the shape of a straight edge and a second stop part 302 in the shape of a recess. When the stop rod 110 is located at the first position, it presses against the first stop part 301 to prevent the folding part from pivoting about the pivot to be folded toward the handle part. When the stop rod 110 is located at the first position, it presses against the second stop part 302 to prevent the folding part from pivoting about the pivot to be unfolded from the handle part. Further, a curved transition surface 303 is provided between the first stop part and the second stop part, and the stop rod contacts the curved transition surface via an elastic force to apply damping to the folding part when the folding part is folded toward the handle part and unfolded from the handle part.

As shown in FIG. 8, the folding part 300 is in the unfolded state, and the stop rod 110 is located at the first position. When the folding part 300 is folded toward the handle part by rotating counterclockwise, the folding part cannot be folded as it is stopped and thereby locked by the stop rod, thus allowing safe cutting operations.

As shown in FIG. 9, the folding part 300 is in the unfolded state, and the stop rod 110 is operated to move to the second position. When the folding part 300 is folded toward the handle part by rotating counterclockwise, the folding part can be folded. Therefore, the folding part can be folded toward the handle part.

As shown in FIG. 10, the folding part 300 is in the folded state, and the stop rod 110 is located at the first position. When the folding part 300 is unfolded toward the handle part by rotating clockwise, the folding part 300 is stopped and locked by the stop rod 110. Therefore, the folding part cannot be unfolded from the handle part. By moving the stop rod to the second position, the folding part can be unfolded from the handle part.

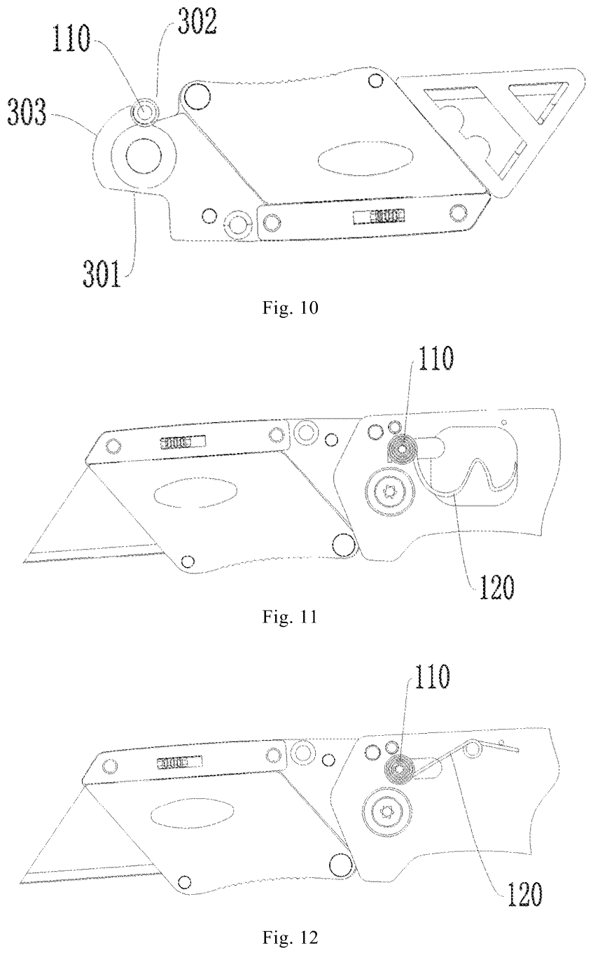

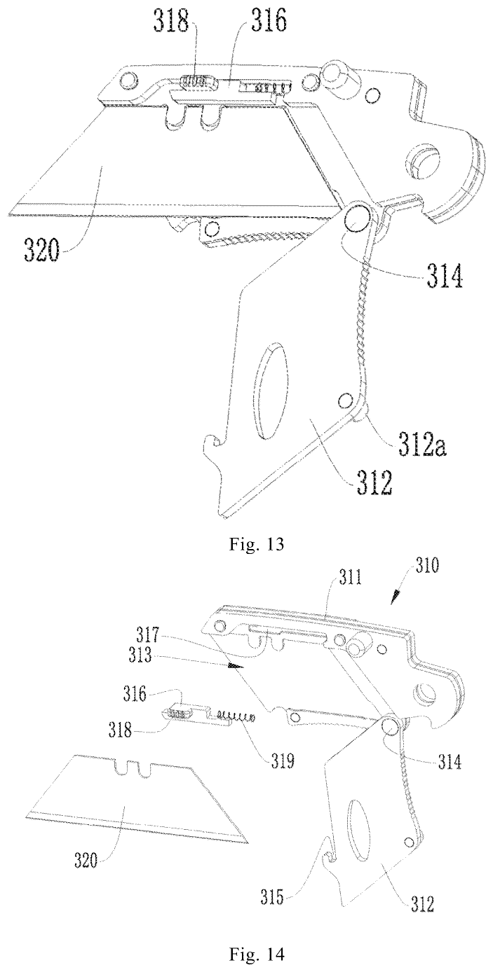

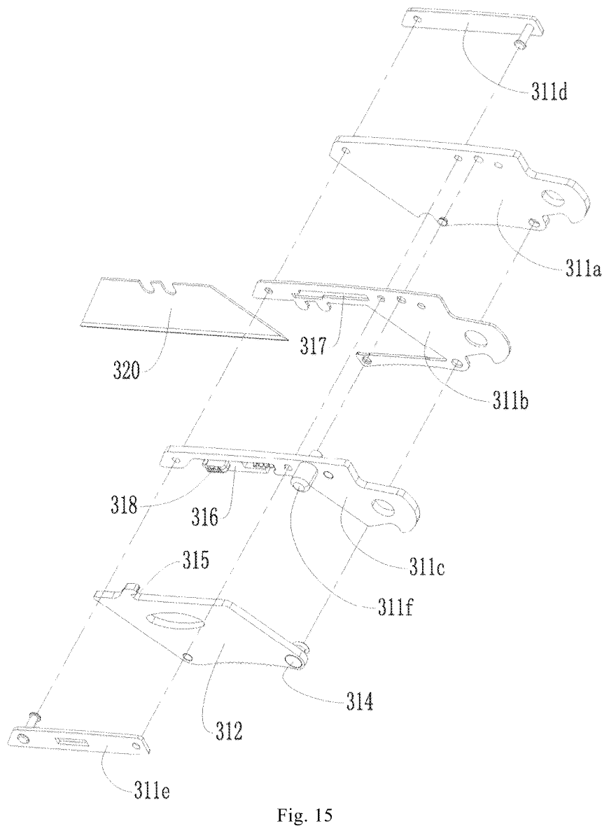

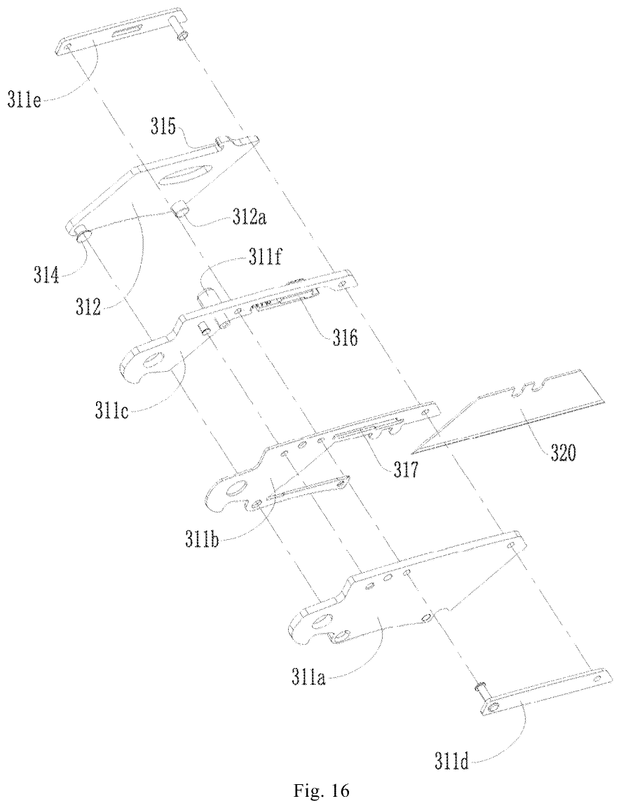

As shown in FIG. 13 to FIG. 14, in this embodiment, to facilitate blade replacement, the folding part comprises a blade holder 310 and a blade 320 replaceably mounted on the blade holder. The blade holder is pivotally coupled to the handle body via the pivot. The blade holder comprises a holder body 311 and a pressure plate 312. The holder body 311 is provided with a mounting recess 313 for mounting the blade. The pressure plate 312 is pivotally coupled to the holder body 311 via a pivot pin 314 so as to pivot to expose the mounting recess or cover the mounting recess. When the pressure plate exposes the mounting recess, it allows for blade replacement; when the pressure plate covers the mounting recess, it serves to tightly press the blade in the mounting recess and avoid blade dislodgement. The pressure plate comprises a locking recess 315. The holder body is provided with an operable movable locking pin 316. When the pressure plate covers the mounting recess, the movable locking pin is inserted into the locking recess via an elastic force, thereby ensuring the pressure plate is located at a position covering the mounting recess. In particular, the holder body is provided with a sliding recess 317 for mounting the movable locking pin, the movable locking pin 316 is disposed in the sliding recess 317 for forward or rearward movement, the movable locking pin comprises a push-operating part 318 protruding from a side surface of the blade holder, and a third elastic element 319 for applying the elastic force to the movable locking pin is provided in the sliding recess. As shown in the figures, the third elastic element is a helical compression spring. Under the elastic force of the third elastic element, the movable locking pin is inserted into the locking recess of the pressure plate.

In particular, the holder body is formed by stacking and fastening plates, and the mounting recess and the sliding recess are formed by stamping a part of the plates. Specifically, the holder body comprises a first side plate 311a, a recess plate 311b, and a second side plate 311c. The recess plate is stamped into a shape shown in the figures. The first side plate and the second side plate are respectively arranged on two sides of the recess plate, clamped between a first clamping plate 311d and a second clamping plate 311e, and then fastened together by fasteners to form an integrated structure. The mounting recess and the sliding recess are formed at corresponding stamping positions of the recess plate. The second side plate is partially missing relative to the first side plate. The missing portion is adapted to the shape of the pressure plate. To facilitate the rotation of the pressure plate, an actuating tab 312a is provided on the pressure plate. The actuating tab extends from the pressure plate toward the first side plate without occupying too much transverse dimension.

To increase the manipulation method of the folding part, an actuating post 311f is provided on the blade holder. When gripping the handle part with the hand, the thumb of the hand can actuate the actuating post to fold or unfold the blade holder.

In this embodiment, although the folding part comprises two parts, i.e., the blade holder and the blade, in other embodiments, it may also be an integrated structure blade pivotally assembled on the handle part directly through a pivot.

In this embodiment, the locking mechanism comprises a stop part and a stop rod 110. An end portion of the stop rod serves as a finger control part 111. The finger control part 111 protrudes from a side surface of a front end of the handle body for finger manipulation. A tail end of the handle body forms a shape feature. The shape feature is a protruding contour that constitutes a squeezing part adapted to be pressed against the palm. The squeezing part serves as a forward force application contour feature 104. When gripping the handle part as shown in FIG. 42, the forward force application contour feature is pressed against the palm, and by using fingers to control the side of the handle part, the fingers can avoid the folding path. In the state shown in FIG. 42, move the finger control part via the finger and thumb rearward to unlock the locking mechanism, and then flick counterclockwise to fold the folding part toward the handle part. Further, the distance L between the finger control part and the forward force application contour feature is 8-12.5 cm, which is adapted to allow the fingers of the same hand are able to manipulate the finger control part when the forward force application contour feature is pressed against the palm.

### Embodiment 2

As shown in FIG. 11, this embodiment differs from Embodiment 1 in the shape of the first elastic element 120. Other structures are the same as those in Embodiment 1, which will not be repeated.

In this embodiment, the linear spring serving as the first elastic element is not in the shape of a semi-circular arc, but in the shape of a letter W, thereby applying a forward elastic force to the stop rod.

### Embodiment 3

As shown in FIG. 12, this embodiment differs from Embodiment 1 in the structural form of the first elastic element 120. Other structures are the same as those in Embodiment 1, which will not be repeated.

In this embodiment, the first elastic element is a torsion spring, an end of the torsion spring is supported onto the handle part, and another end of the torsion spring acts on the stop rod to apply a forward elastic force to the stop rod.

### Embodiment 4

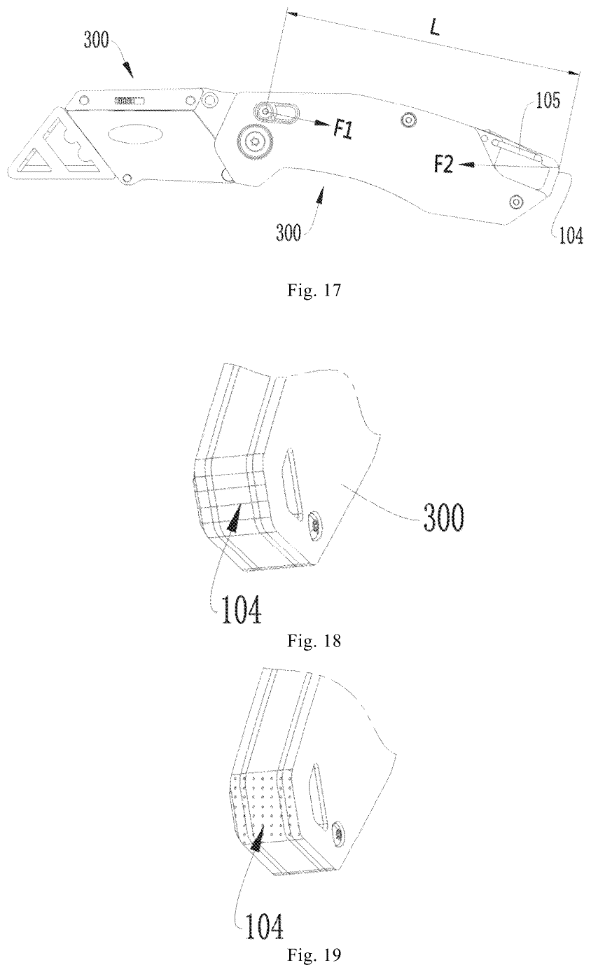

As shown in FIG. 17, this embodiment differs from Embodiment 1 in the structural difference of the forward force application contour feature. Other structures are the same as those in Embodiment 1, which will not be repeated.

In this embodiment, the tail of the handle is provided with a hanging ring 105 for hanging the folding knife. In addition, an outer periphery contour of a rear end of the hanging ring serves as a forward force application contour feature 104 for being pressed against the palm when gripping the handle part. In other embodiments, the forward force application contour feature 104 also manifests as:
the forward force application contour feature is a shape feature formed on the handle body, such as a squeezing part formed at a tail end of the handle body and adapted to be pressed against the palm; or, a protrusion and/or pit located on a side surface of the handle body that and adapted to fingers applying a forward control force.

Alternatively, the handle part comprises a handle body and a structural member provided on the handle body, and the forward force application contour feature 104 is a shape feature formed on the structural member or is provided by the structural member. For example, it is a squeezing part located at a rear end of the handle body and adapted to be pressed against a palm; or a protrusion, loop, recess, or bent edge located on a side surface of the handle part and adapted for a finger to apply the forward control force.

Alternatively, the handle part comprises a handle body, and the forward force application contour feature 104 is provided by an accessory provided on the handle body for removal in use.

Alternatively, the handle part comprises a handle body, and the forward force application contour feature 104 is a squeezing member assembled at a tail of the handle body and configured to increase a contact force with a palm.

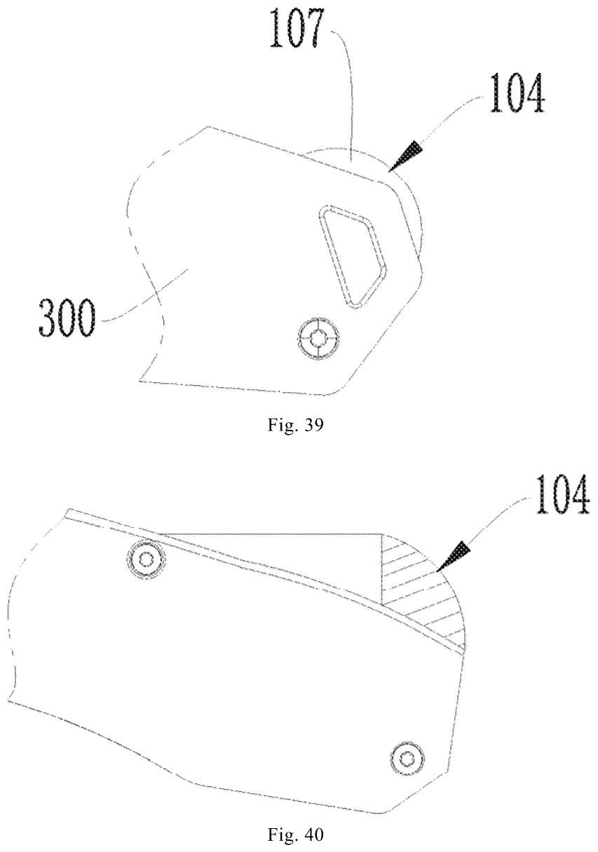

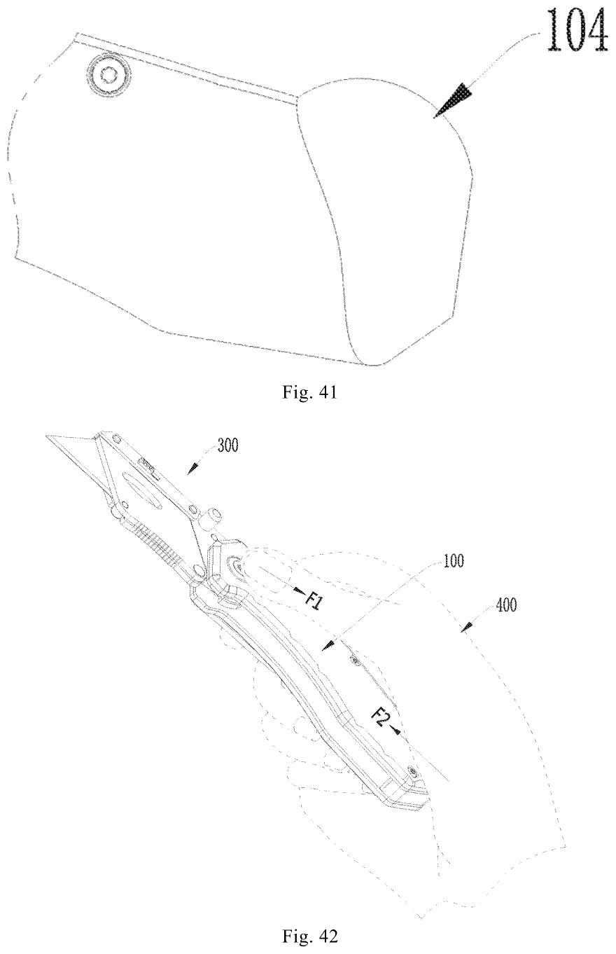

Specifically, referring to FIG. 18 to FIG. 41,

As shown in FIG. 18 to FIG. 19, to enhance the contact force with the palm and prevent the forward force application contour feature from slipping off the palm, the forward force application contour feature is provided with textured patterns. The patterns shown in FIG. 18 are strip grooves, while the patterns shown in FIG. 19 are protruding dots.

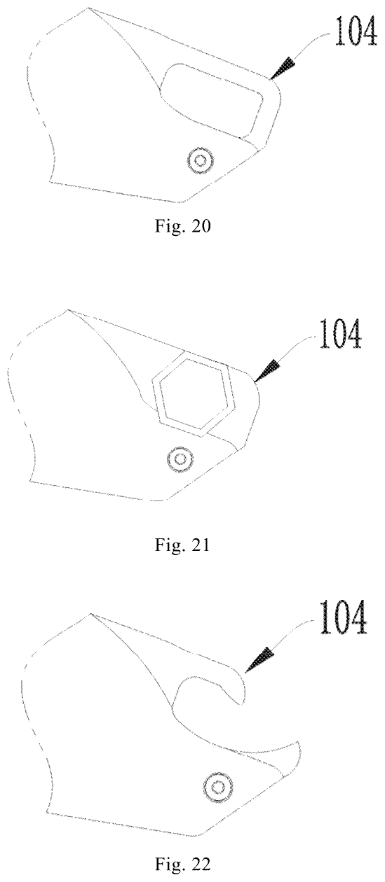

FIG. 20 shows a hanging hole provided at the rear end of the handle body. A peripheral contour of the hanging hole forms the forward force application contour feature.

FIG. 21 shows a hexagonal nut screwing hole provided at the rear end of the handle body. A peripheral contour of the hexagonal nut screwing hole forms the forward force application contour feature.

FIG. 22 shows a bottle opener provided at the rear end of the handle body. A peripheral contour of the bottle opener forms the forward force application contour feature.

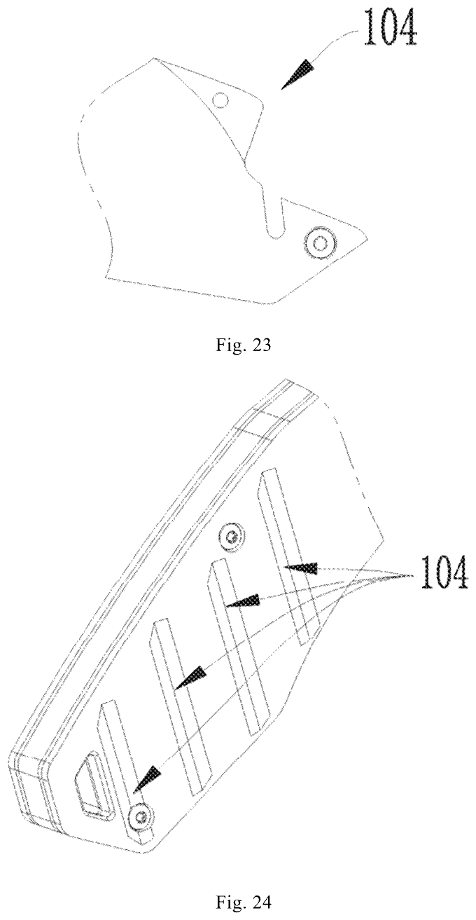

FIG. 23 shows a cutter recess provided at the rear end of the handle body. A peripheral contour of the cutter recess forms the forward force application contour feature.

FIG. 24 shows parallel grooves provided on the side surface of the handle body. Fingers are put in the grooves when gripping the handle body.

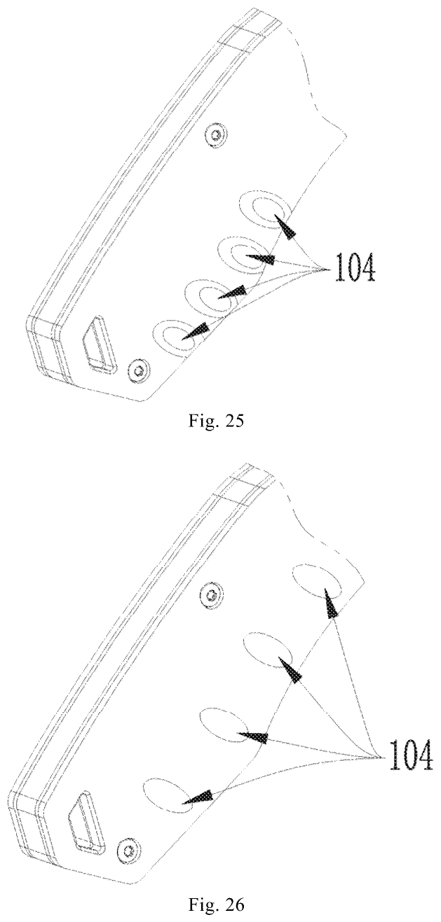

FIG. 25 shows a plurality of pits provided on the side surface of the handle body. Fingers are put in the pits when gripping the handle body.

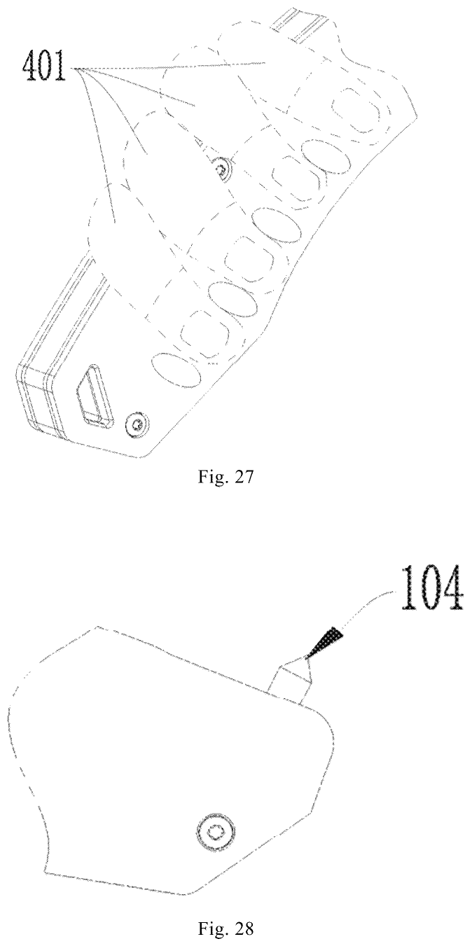

FIG. 26 shows a plurality of protrusions provided on the side surface of the handle body. Fingers are put between adjacent protrusions as shown in FIG. 27 when gripping the handle body.

FIG. 28 shows a striking head provided at the rear end of the handle body. The striking head is a structural member provided on the handle body and serves as a squeezing part located at the rear end of the handle body and adapted to be pressed against a palm.

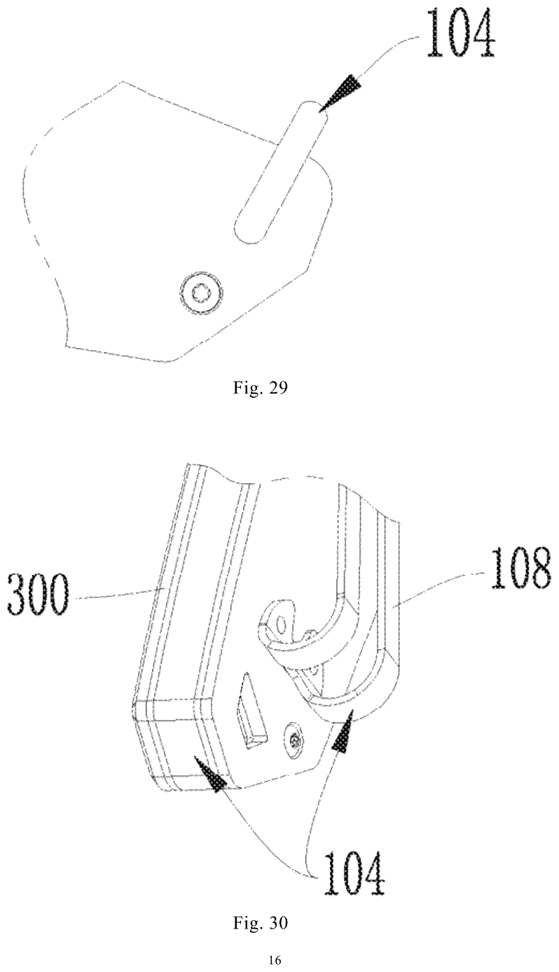

FIG. 29 shows a situation where the hanging ring is provided in an alternative form at the rear end of the handle body. This hanging ring may be reversed in position, and when reversed to the position shown in the figure, it serves as the squeezing part located at the rear end of the handle body and adapted to be pressed against a palm.

FIG. 30 shows a belt clip provided on the side surface of the handle body. A rear end of the belt clip is bent forward to form a protrusion, so as to allow a finger to apply a forward control force to the protrusion as shown in FIG. 32.

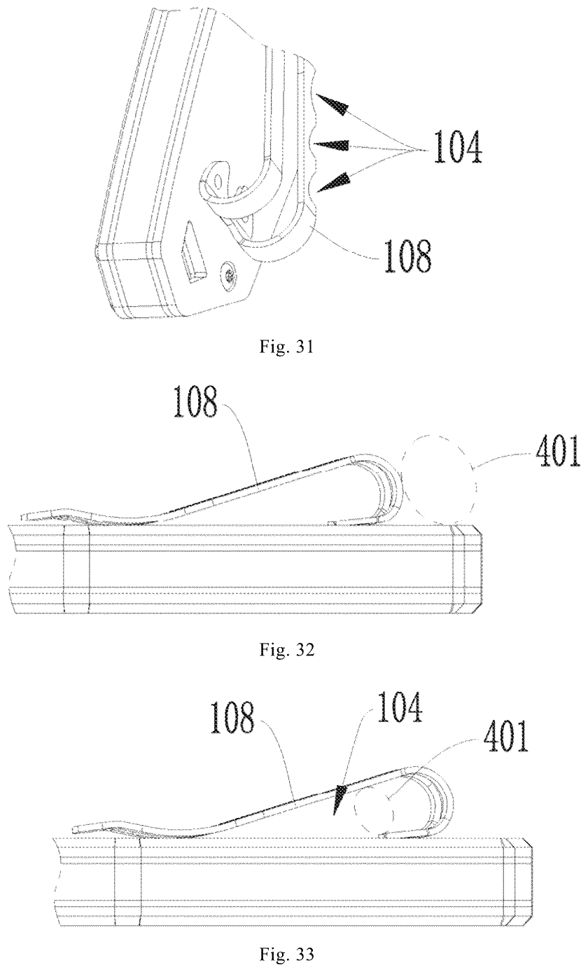

FIG. 31 shows a belt clip provided on the side surface of the handle body. An edge of the belt clip is provided with a recess, so as to allow a finger to be put in the recess to apply a forward control force to the handle body.

FIG. 33 shows a belt clip provided on the side surface of the handle body. An accommodating space is formed between the belt clip and the handle body, so as to allow a finger to stretch into the accommodating space to apply a forward control force to the handle body.

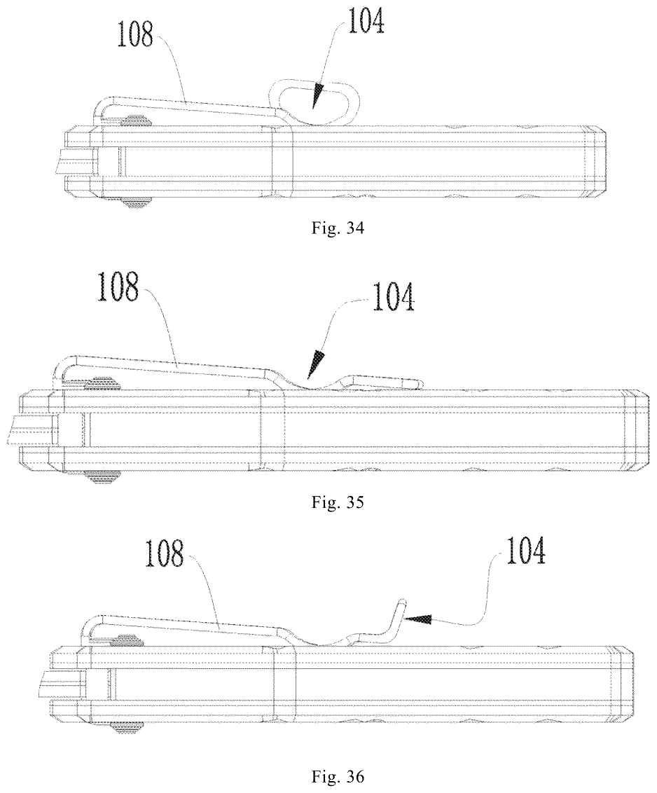

FIG. 34 shows a belt clip provided on the side surface of the handle body. An end of the belt clip is bent into a loop, and an outer wall of a rear portion of the loop forms a protrusion, so as to allow a finger to apply a forward control force to the protrusion.

FIG. 35 shows a belt clip provided on the side surface of the handle body. A middle portion of the belt clip is provided with a recess, so as to allow a finger to be put in the recess to apply a forward control force to the handle body.

FIG. 36 shows a belt clip provided on the side surface of the handle body. A rear end of the belt clip is bent toward a side surface to form a bent edge, so as to allow a finger to be put behind the bent edge to apply a forward control force to the handle body.

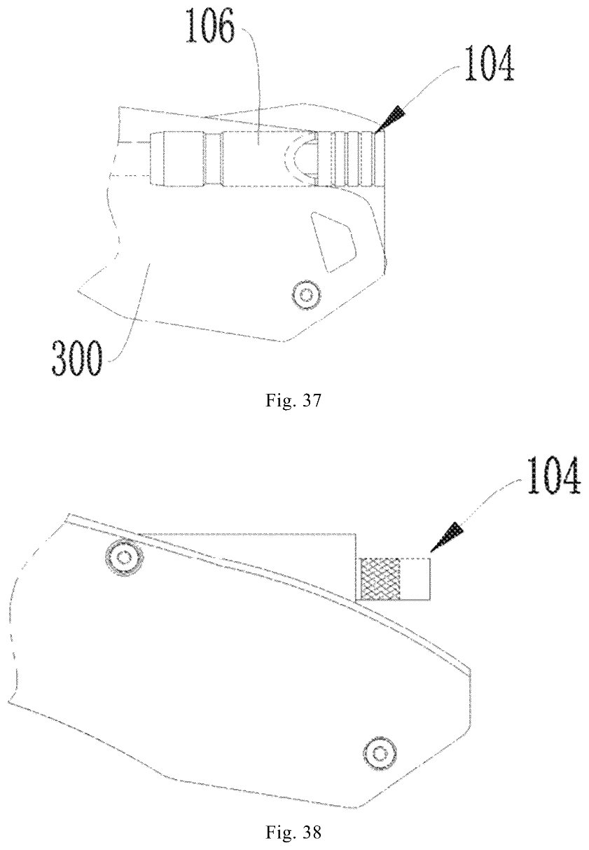

FIG. 37 shows a screwdriver bit 106 or a flint removably provided at the rear end of the handle body. When the screwdriver bit 106 or flint is provided at the rear end of the handle body in the state shown, it is pressed against the palm to allow the palm to apply a forward control force to the handle body. When the screwdriver bit 106 or flint is removed from the rear end of the handle body, a shape feature at the rear end of the handle body, which matches with the screwdriver bit 106 or flint, is pressed against the palm to allow the palm to apply a forward control force to the handle body.

FIG. 38 shows a structure similar to that in FIG. 37, where a removable miniature flashlight is provided at the rear end of the handle body. When the miniature flashlight is provided at the rear end of the handle body in the state shown, it is pressed against the palm to allow the palm to apply a forward control force to the handle body. When the miniature flashlight is removed from the rear end of the handle body, a shape feature at the rear end of the handle body, which matches with the miniature flashlight, is pressed against the palm to allow the palm to apply a forward control force to the handle body.

FIG. 39 to FIG. 41 show a squeezing member provided on the side surface of the rear portion of the handle body, on the upper surface of the rear portion of the handle body, and at the rear portion of the handle body, respectively. The squeezing member is preferably made of a material such as rubber to increase the contact force with the palm, so that the squeezing member can be pressed against the palm to allow the palm to apply a forward control force to the handle body. The squeezing member may be embodied as a cap, a plug, or the like.

As described above, the structures shown in FIG. 17 to FIG. 23 are all a squeezing part formed at the rear end of the handle body and adapted to be pressed against a palm; the structures shown in FIG. 24 to FIG. 27 are all a protrusion or/and a pit located on the side surface of the handle body and adapted for a finger to apply a forward control force; the structures shown in FIG. 28 to FIG. 36 are all a structural member provided on the handle body, and the forward force application contour feature 104 is a shape feature formed on the structural member or is provided by the structural member; the structures shown in FIG. 37 to FIG. 38 show that the forward force application contour feature 104 is provided by an accessory provided on the handle body for removal in use; the structures shown in FIG. 39 to FIG. 41 show that the forward force application contour feature 104 is a squeezing member assembled at the tail of the handle body and configured to increase the contact force with a palm.

The present invention describes various structural forms of the forward force application contour feature 104, aiming at demonstrating that different structural forms can be employed to achieve the application of the forward control force to the forward force application contour feature by the same hand during use, thereby ensuring that the handle part does not slip from the hand. Under this teaching, other structural forms may also be implemented during practical implementation, which will not be exhaustively listed herein.

1. A folding knife, comprising a handle part and a folding part pivotally coupled to the handle part via a pivot so as to be folded toward the handle part and unfolded from the handle part, a rear end of the folding part and a front end of the handle part being provided with a locking mechanism for locking the folding part relative to the handle part, wherein the locking mechanism comprises a finger control part for unlocking the locking mechanism, the finger control part protrudes from a side surface of the front end of the handle part for a finger to apply an unlocking force (F1) rearward, the handle part is provided with a forward force application contour feature, and a distance (L) between the finger control part and the forward force application contour feature is adapted to allow that fingers of a single hand are able to manipulate the finger control part as the same hand grips and controls the forward force application contour feature, and the hand applies a forward control force (F2) to the forward force application contour feature when the fingers apply the unlocking force (F1) rearward to the finger control part.

2. The folding knife of claim 1, wherein the handle part comprises a handle body, and the forward force application contour feature is a shape feature formed on the handle body.

3. The folding knife of claim 2, wherein the shape feature is any one of the following features:
(1) a squeezing part formed at a rear end of the handle body and adapted to be pressed against a palm;
(2) a protrusion and/or a pit located on a side surface of the handle body and adapted for a finger to apply the forward control force.

4. The folding knife of claim 1, wherein the handle part comprises a handle body and a structural member provided on the handle body, and the forward force application contour feature is a shape feature formed on the structural member or is provided by the structural member.

5. The folding knife of claim 4, wherein the shape feature is any one of the following features:
(1) a squeezing part located at a rear end of the handle body and adapted to be pressed against a palm;
(2) a protrusion, loop, recess, or bent edge located on a side surface of the handle part and adapted for a finger to apply the forward control force.

6. The folding knife of claim 1, wherein the handle part comprises a handle body, and the forward force application contour feature is provided by an accessory provided on the handle body for removal in use.

7. The folding knife of claim 1, wherein the handle part comprises a handle body, and the forward force application contour feature is a squeezing member assembled at a tail of the handle body and configured to increase a contact force with a palm.

8. The folding knife of claim 1, wherein the handle part comprises a handle body, and the locking mechanism comprises a stop part provided at a rear end of the folding part and a stop rod provided at a front end of the handle body, an end portion of the stop rod serves as the finger control part, the stop rod is configured to operatively move forward or rearward between a first position and a second position, the stop rod, when located at the first position, presses against the stop part to prevent the folding part from pivoting about the pivot, the stop rod, when located at the second position, avoids the stop part to allow the folding part to be pivotable about the pivot, and the stop rod is biased toward the first position via an elastic force.

9. The folding knife of claim 8, wherein the stop part comprises a first stop part and a second stop part, and the stop rod, when located at the first position, presses against the first stop part to prevent the unfolded folding part from being folded toward the handle body or presses against the second stop part to prevent the folded folding part from being unfolded from the handle body.

10. The folding knife of claim 9, wherein the first stop part is one of a straight edge and a recess, and the second stop part is one of a recess and a straight edge.

11. The folding knife of claim 9, wherein a curved transition surface is provided between the first stop part and the second stop part, and the stop rod contacts the curved transition surface via an elastic force to apply damping to the folding part when the folding part is folded toward the handle body and unfolded from the handle body.

12. The folding knife of claim 8, characterized in that the handle body is provided with a transverse through hole, the transverse through hole is a flat elongated hole or an arc-shaped hole extending in a forward and rearward direction, a front end of the flat elongated hole or the arc-shaped hole defines the first position, a rear end of the flat elongated hole or the arc-shaped hole defines the second position, and the stop rod is transversely assembled to the handle body and passes through the transverse through hole, thereby being guided to move forward or rearward.

13. The folding knife of claim 12, wherein two ends of the stop rod extend beyond a side surface of the handle body.

14. The folding knife of claim 12, wherein a first elastic element for providing the elastic force is assembled on the handle body.

15. The folding knife of claim 14, wherein the first elastic element is a curved linear spring, an end of the linear spring is supported onto the handle body, and another end of the linear spring acts on the stop rod to apply a forward elastic force to the stop rod.

16. The folding knife of claim 15, wherein an end of the linear spring is provided with a hook, and the hook is hung on the stop rod.

17. (canceled)

18. The folding knife of claim 14, wherein the first elastic element is a torsion spring, an end of the torsion spring is supported onto the handle body, and another end of the torsion spring acts on the stop rod to apply a forward elastic force to the stop rod.

19. The folding knife of claim 14, wherein two first elastic elements are symmetrically provided on the handle body.

20. The folding knife of claim 1, wherein the folding part comprises a blade holder and a blade replaceably mounted on the blade holder, the blade holder is pivotally coupled to the handle part via the pivot, the blade holder comprises a holder body and a pressure plate, the holder body is provided with a mounting recess for mounting the blade, the pressure plate is pivotally coupled to the holder body via a pivot pin so as to pivot to expose the mounting recess or cover the mounting recess, the pressure plate comprises a locking recess, the holder body is provided with an operable movable locking pin, and the movable locking pin is inserted into the locking recess via an elastic force when the pressure plate covers the mounting recess.

21. The folding knife of claim 20, wherein the holder body is provided with a sliding recess for mounting the movable locking pin, the movable locking pin is disposed in the sliding recess for forward or rearward movement, the movable locking pin comprises a push-operating part protruding from a side surface of the blade holder, and a third elastic element for applying the elastic force to the movable locking pin is provided in the sliding recess.

22-23. (canceled)
